(19) United States
(12) Patent Application Publication
(10) Pub. No.: US 2004/0129198 A1
(43) Pub. Date: Jul. 8, 2004

(54) Semi-fixed type bookmark

(75) Inventor: Chung-Wei Wu, Chung-Ho (TW)

Correspondence Address: BACON & THOMAS, PLLC, 625 SLATERS LANE, FOURTH FLOOR, ALEXANDRIA, VA, 22314

(73) Assignee: LITE-ON TECHNOLOGY CORPORATION, Taipei (TW)

(21) Appl. No.: 10/411,250

(22) Filed: Apr. 11, 2003

(30) Foreign Application Priority Data
Jan. 2, 2003 (TW) 092200024

(51) Int. Cl. B42D 9/00

(52) U.S. Cl. 116/239

(57) ABSTRACT

The present invention discloses a semi-fixed type bookmark, which comprises a fixing clamp and a rope ribbon fixed thereon. The rope ribbon is capable of inserting between two adjacent pages of a book in order to mark a reading point when the book is closed. Also, the clamp can be fixed on a certain place of the book to prevent the bookmark from missing when book is being read.

### FIELD OF THE INVENTION

The present invention relates to a semi-fixed type bookmark, more particularly to a bookmark with a fixer clamp and a rope ribbon fixed thereon.

### BACKGROUND OF THE INVENTION

There are two kinds of conventional bookmarks: a fixed bookmark (as shown in FIG. 1) and a removable bookmark (as shown in FIG. 2). The fixed bookmark is usually a rope and is fixed on a hardcover book. Such a fixed bookmark is convenient for reading but cost high. The removable bookmark could be a paper-sheet, a plastic or metal sheet having two opposite clamping parts, or a paper-sheet having a clamp. Such a removable bookmark is easily lost since it should be removed when reading.

### SUMMARY OF THE INVENTION

The present invention relates to a semi-fixed type bookmark comprising a fixer clamp and a rope ribbon fixed thereon. The fixer clamp is used for clamping on the edge of a book while reading and is removed when reading is over. The rope ribbon is used for marking a reading point of the book as a conventional bookmark does.

Therefore, the object of the present invention is to provide a semi-fixed type bookmark, the bookmark according to the present invention can be clamped and fixed on a book while reading in order to avoid a trouble for finding the bookmark and to prevent the bookmark from missing.

These objects and the other objects, features, and advantages will be apparent to those people skilled in the art from the following detailed description in connection with the drawings.

### BRIEF DESCRIPTION OF THE DRAWINGS

FIG. 1 shows a schematic view of a conventional fixed bookmark;

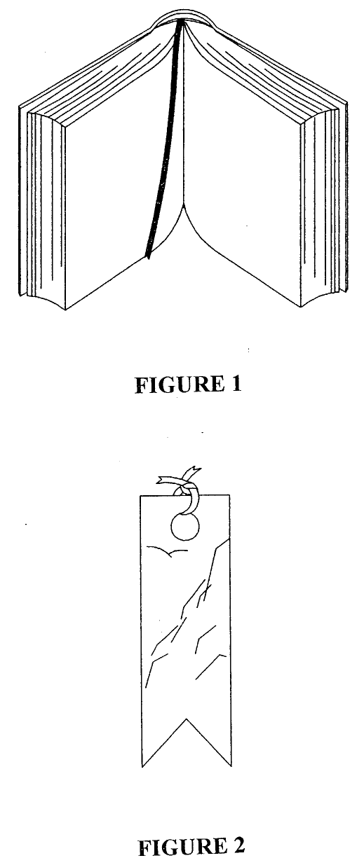

FIG. 2 shows a schematic view of a conventional removable bookmark;

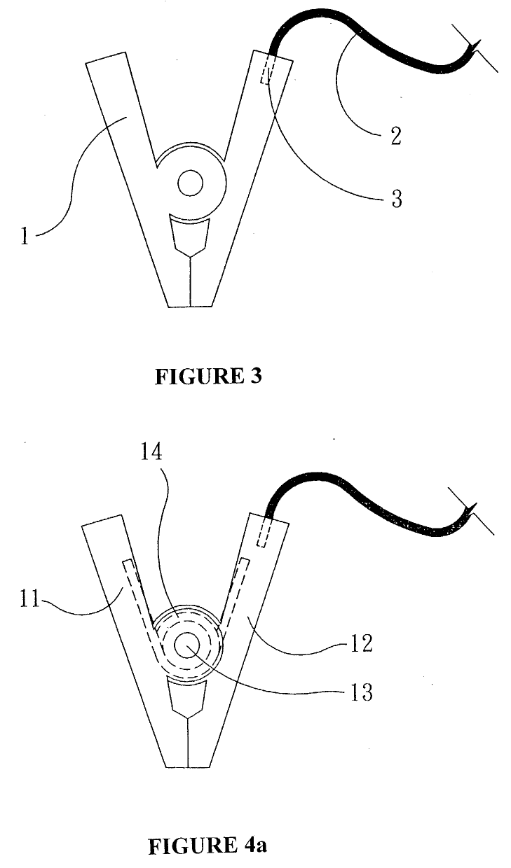

FIG. 3 shows a perspective view of a semi-fixed type bookmark according to the present invention;

FIGS. 4a to 4c show a structure view of a fixed clamp of a semi-fixed type bookmark according to the present invention, respectively;

FIGS. 5a and 5b show a perspective view of joining structures of semi-fixed type bookmarks according to the present invention with different kinds of a fixed clamp and a rope ribbon; and

FIG. 6 shows a perspective view for a usage state of a semi-fixed type bookmark According to the present invention.

### DETAILED DESCRIPTION OF THE INVENTION

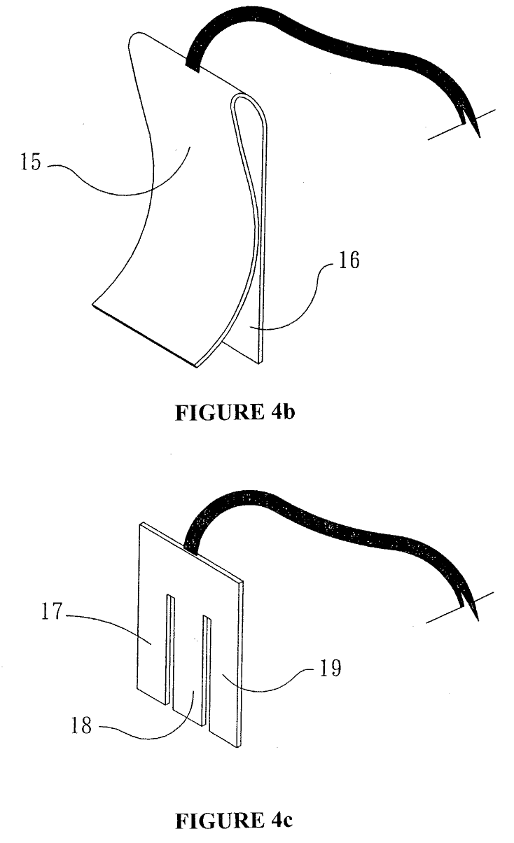

First at all, please refer to FIG. 3. FIG. 3 shows a perspective view of a semi-fixed type bookmark according to the present invention. A semi-fixed type bookmark comprises a fixer clamp 1 and a rope ribbon 2. The fixer clamp 1 is connected with the rope ribbon 2 at a joint 3.

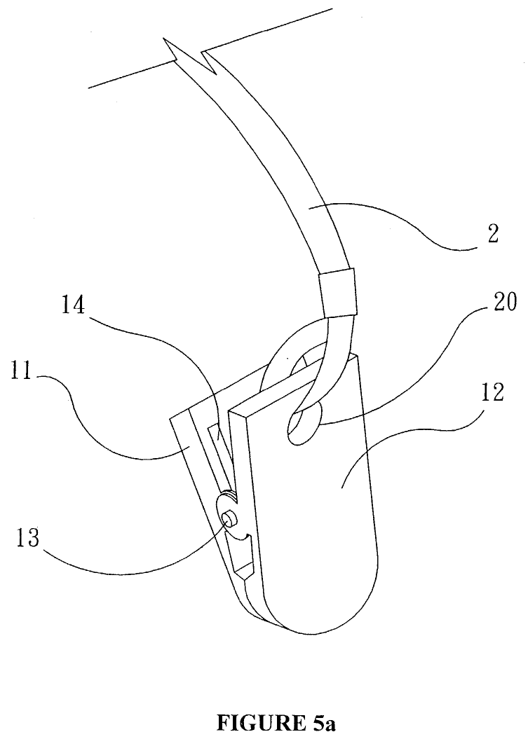

FIG. 4a shows a detailed structure of a fixer clamp of the first embodiment according to the present invention. The fixer clamp 1 includes two clamping plates 11 and 12. Two clamping plates 11 and 12 and a wound spring 14 are integrated together through a connector stick 13. The two clamping plates 11 and 12 can be clamped together or separated from each other by the resilience force of the spring 14.

FIG. 4b shows a detailed structure of a fixer clamp according to the second embodiment of the present invention. A fixing clamp consists a resilient sheet bent to form two clamping plates 15 and 16. The two clamping sheets 15 and 16 are pressed against each other. The fixer clamp can be integrated into one body from molding if it is plastic. The two clamping sheets 15 and 16 are separated from each other and then are fixed on the edge of a book while reading.

FIG. 4c shows a detailed structure of a fixer clamp of the third preferred embodiment according to the present invention. The fixer clamp is made from a plastic or metal sheet, which is partly cut off to form three parts 17, 18, and 19. While reading, the intermediate part 18 is pulled apart from the parts 17 and 19, and then, the clamp is placed on a book and fixed on it through a clamping force among the parts 17, 18, and 19.

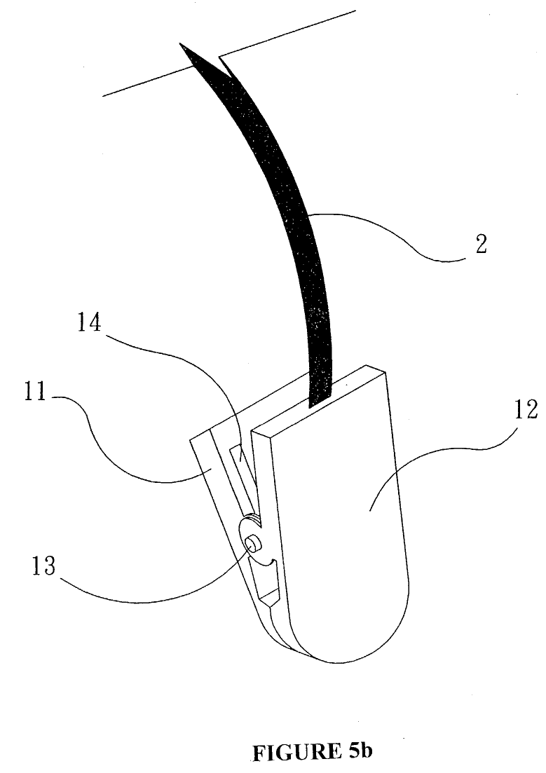

FIGS. 5a and 5b show a joining structure view of the semi-fixed type bookmark according to the present invention. From FIG. 5a, the clamping sheet 15 or 16 is further provided with a hole 20 for passing the rope 2 through in. The rope 2 is then tightened by a metal or plastic piece. From FIG. 5b, the rope 2 is molded with the clamping sheets 15 or 16 and integrated into one body.

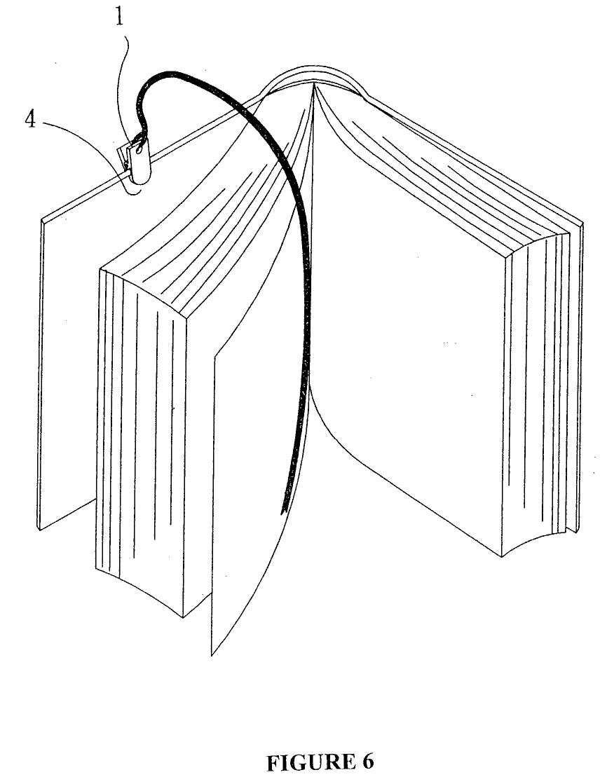

FIG. 6 shows how to use the present fixed clamp of the semi-fixed type bookmark. While reading, the fixer clamp 1 is fixed on a certain place of a book 4. After reading, the rope ribbon is inserted between two pages.

Although the present invention has been described by the above embodiment, the present invention is not limited by the embodiment. Person skilled in the art would make various changes or modification without departing from the spirit and the scope of the present invention. The present invention is only limited by the appended claims.

What is claimed is:

1. A semi-fixed type bookmark, comprising a fixing clamp and a rope ribbon fixed thereon, said rope ribbon being capable of being placed between two adjacent pages of a book in order to mark a reading point when said book is closed and the fixer clamp being clamped on a certain place of said book while reading.

2. The semi-fixed type bookmark according to claim 1, wherein said fixer clamp is a paper-sheet, a plastic sheet, a paper-sheet having a clamp, or a metal sheet.

3. The semi-fixed type bookmark according to claim 1, wherein said fixer clamp is molded with said rope ribbon and integrated in to one body.

4. The semi-fixed type bookmark according to claim 1, wherein said fixer clamp is provided with a hole for said rope ribbon to pass through.

5. The semi-fixed type bookmark according to claim 1, wherein said rope ribbon is a cloth strip, a plastic strip, or a paper strip.
